(19) United States
(12) Patent Application Publication
(10) Pub. No.: US 2006/0226175 A1
(43) Pub. Date: Oct. 12, 2006

(54) Quick disconnect dip tube coupling assembly

(75) Inventors: Ronald Sledzieski, Southbury, CT (US); John Corrigan, Washington, CT (US); Andy Tyler, Southbury, CT (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sealed Air Corporation (US)

(21) Appl. No.: 11/094,897

(22) Filed: Mar. 31, 2005

(51) Int. Cl. B67D 5/40

(52) U.S. Cl. 222/382

(57) ABSTRACT

A coupling assembly that provides a connection between a dip tube and a pumping system is used to remove chemicals from a container. The coupling assembly allows the pumping system to be quickly disconnected from a dip tube in an empty container and reconnected to fresh container where a dip tube is inserted at the point of use. It includes a quick disconnect assembly adapted to releasably interconnect the coupling assembly with a dip tube.

### BACKGROUND OF THE INVENTION

Plastic foams are formed using chemicals that are pumped from drums and other large supply containers. Using a pumping device, the chemicals can be pumped directly from the supply containers and combined with other chemicals that react to form the foam. When a container is emptied, the pumping device must be disconnected from the empty container and reconnected to a full container, a process which can take several minutes. During this process, it is important that air not be introduced into the pumping system.

In one known type of system, the pumping device extends into the container itself. When changing from an empty supply container to a fresh container, the pumping device, still wet with chemical, must be lifted out from the container and transferred to the fresh container along with the associated hoses and cables, a process that can be both difficult and messy.

In another known system, an external pumping device is used to withdraw chemicals from the supply containers. For this type of system, it has been proposed to use a coupling device to facilitate connecting and disconnecting the external pumping system and the supply containers. However, this approach requires each container to have a standard mating part (e.g. container side coupling) for connection to the coupling device. Suppliers of the chemical raw materials used in foam manufacture provide a variety of different compositions and grades for specific purposes, and the containers used by these suppliers may be of different sizes or configurations and sourced from several different vendors. This presents logistical hurdles and cost considerations that make it impractical to have all of the supply containers used in foam manufacture equipped with a single standard container side coupling. It would be desirable to have a coupling system that is not fettered by these limitations.

### BRIEF SUMMARY OF THE INVENTION

The present invention overcomes the above limitations and provides a device and system to facilitate quickly and efficiently disconnecting a pumping device from an empty container and reconnecting it to a full container. Containers of the type described above include a surface with an opening through which a liquid in the container may be withdrawn, and the container can be positioned so that this opening is oriented at the top of the container. At the point of use, the container opening is unsealed and dip tube is inserted through the opening and into the liquid so that it can be pumped out. The present invention provides an advantageous coupling device for connecting the pumping system to the dip tube. The coupling device includes a body, a pump-side connector adapted to be connected to a pumping system, and a container-side connector adapted to be connected to the dip tube. The container-side connector includes a quick disconnect assembly that allows for quickly disconnecting the coupling device from the dip tube of an empty container and reconnecting it to a fresh container where a dip tube is inserted into the container opening. The quick disconnect assembly includes a tubular male coupling member and a cooperating tubular female coupling member configured to receive the male coupling member. The male coupling member has an outwardly facing cylindrical exterior surface and the female coupling member has a corresponding inwardly facing interior cylindrical surface arranged to engage the exterior cylindrical surface of the male coupling member to form a releasable interconnection therewith. The outwardly facing outside cylindrical surface of the female coupling member is configured to be seated in the opening of the container and also forms a grasping surface that allows for manually connecting and disconnecting the coupling members of the quick release assembly.

The coupling device also preferably includes a sensor that is operable to monitor the flow of liquid through the coupling. In a preferred embodiment of the invention, the sensor is a capacitive sensor operable to detect when air begins to be pumped through the coupling device, which indicates that the container is empty, so that the pump can be shut down before more air is drawn into the system.

In a further aspect of the invention, the coupling device may include a check valve operable to prevent liquid from flowing back from the coupling through the container-side connector as well as to prevent spilling when the quick disconnect assembly is disconnected.

Further features and aspects of the present invention will be apparent from the detailed description which follows and from the accompanying drawings.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a side view showing the coupling device connected to a dip tube and being used to empty a container;

FIG. 2 is a perspective view of the assembled coupling device;

FIG. 3 is an exploded view of the coupling device;

FIG. 4 is a partial cross-sectional view of the coupling device;

FIG. 5 is a perspective view showing how the coupling is connected to a dip tube;

FIG. 6 is a cutaway perspective view of an upper portion of the coupling device;

FIG. 7 is a detailed perspective view of the male coupling member of the quick disconnect assembly; and

FIG. 8a-8c are perspective views showing how the coupling device can be readily disconnected from one dip tube and reconnected to another.

### DETAILED DESCRIPTION OF THE INVENTION

The present invention now will be described more fully hereinafter with reference to the accompanying drawings, in which some but not all embodiments are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

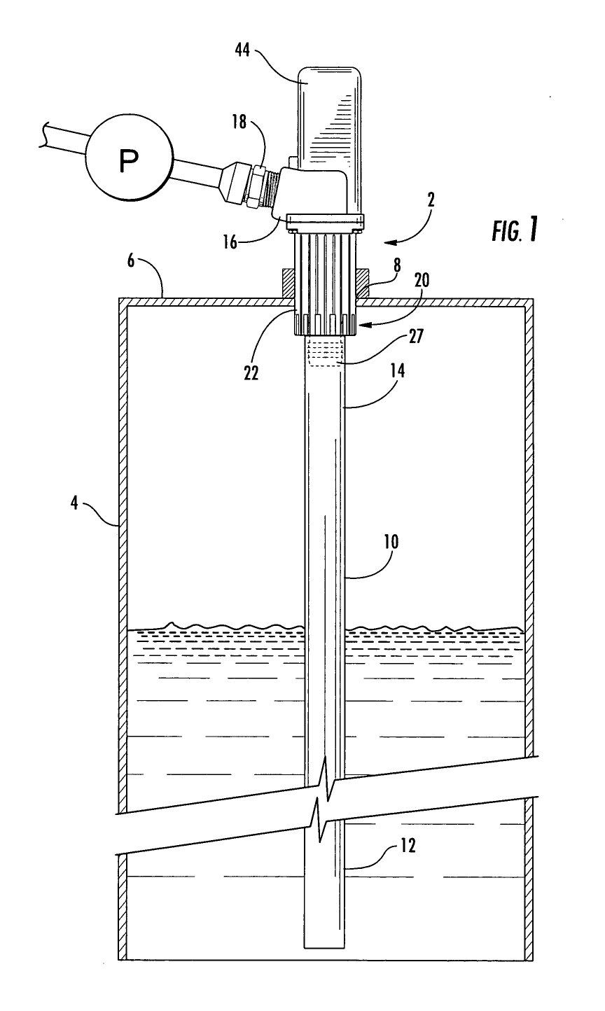

FIG. 1 illustrates a system for dispensing liquid from a container 4. The container 4 has a top surface 6 and an opening 8 through which the liquid may be withdrawn by pumping. A dip tube 10 is inserted into the container 4 through the opening 8 with its lower end 12 immersed in the liquid material within the container and with its upper end 14 adjacent the top surface 6 of the container 4.

According to the present invention a coupling device, generally indicated at 2, is provided for connecting the dip tube 10 to an external pumping system P. The coupling device 2 includes a body 16, a pump-side connector 18 adapted to be connected to a flexible hose of the pumping system, and a container-side connector 20 adapted to be connected to the dip tube 10. The container-side connector comprises a quick disconnect coupling assembly 22 to facilitate disconnecting the coupling device 2 from the dip tube of an empty container and reconnecting it to a fresh container where a dip tube in inserted into the container at the point of use.

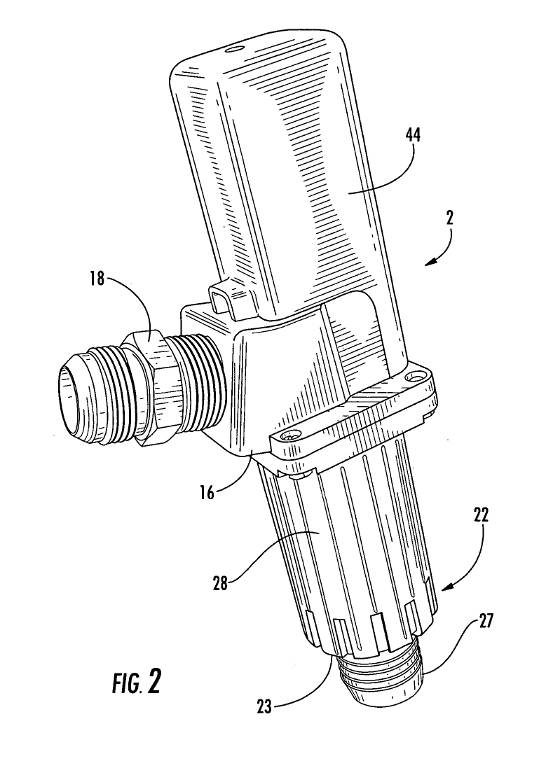

FIG. 2 shows a perspective view of the fully assembled coupling device 2. In the embodiment of the invention shown in FIG. 2, the pump-side connector 18 is in the form of a nipple with threaded opposite ends, with one end threaded into the body 16 and with an outwardly extending threaded end adapted to be connected to a hose of the pumping system.

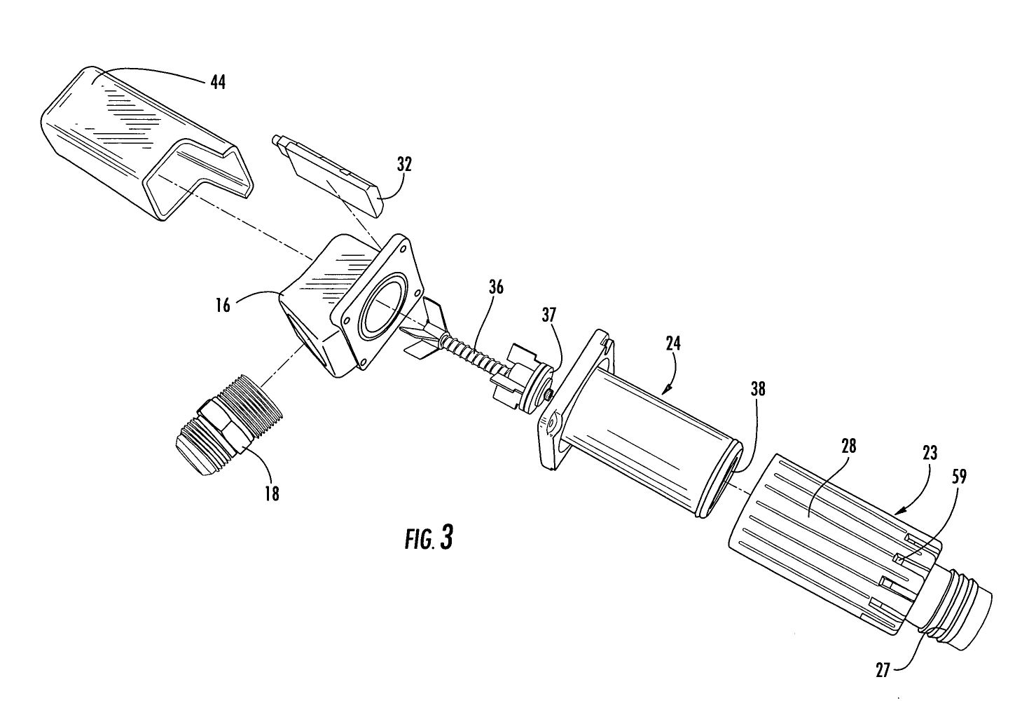

The quick disconnect assembly 22 includes a tubular female coupling member 23, which is visible in FIG. 2, and a cooperating male coupling member 24 seen in FIG. 3. The female coupling member 23 includes a cylindrical wall 25 having an outwardly facing cylindrical surface 28 which is configured to be received by and seated in the opening 8 of container 4. When thus positioned in the container opening 8, the coupling member 23 supports the dip tube 10 in the container. In the embodiment shown, the outwardly facing cylindrical surface 28 has a series of axially extending grooves formed therein. When the female coupling member 23 is seated in the container opening 8 as shown in FIG. 1, these grooves define passageways for air to enter the container as the liquid chemical is emptied. These grooves also serve to provide a non-slip surface to the female coupling member 23 when manually disconnecting and connecting the coupling members. In the embodiment shown, the female coupling member 23 has a barbed friction fit connector 27 at its lower end for connecting to the dip tube 10, and the opposite upper end of the coupling member is open and configured for receiving the male coupling member 24. The barbed friction fit connector 27 is suitable for connecting to a dip tube 10 formed of relatively inexpensive disposable tubing or plastic pipe, and the female coupling member 23 may also be fabricated so that it may be disposed of after a single use. In alternative embodiments, the female coupling member 23 and the dip tube 10 may be formed as one piece or as two pieces permanently attached to each other. In practice, a supply of the dip tubes may be provided to the user, each already provided with a female coupling member 23 at one end, so that a fresh dip tube can be used each time a fresh supply container needs to be connected to the pumping system.

When the quick disconnect assembly 22 is assembled, the male coupling member 24 slides into the female coupling member 23 and forms a fluid-tight seal and also establishes a releasable interconnection between the male and female coupling members. In the particular embodiment shown and described herein, the releasable interconnection is a friction fit. However, it is contemplated that the other specific interconnection configurations may be utilized, such as a threaded interconnection or a bayonet-type releasable interconnection.

The male coupling member 24 also houses a check valve 36. The check valve 36 functions as a backflow preventer to prevent liquid from flowing back from the coupling device 2 through the container-side connector 20. This reduces the likelihood of leakage and spilling when the female coupling member 23 is disconnected from the male coupling member 24. The check valve 36 includes a spring-loaded plunger-mounted valve member 37 that engages a valve seat 38 formed at the end of cylindrical male coupling member 24. During pumping, the suction pressure of liquid being pumped through the coupling device 2 will unseat the valve member 37 and allow liquid to flow past the valve member 37 and into the body 16 of the coupling device. When there is no pressure differential, the spring force seats the valve member 37 so that there will be no backflow of liquid through the coupling or leakage upon disconnection of the coupling members.

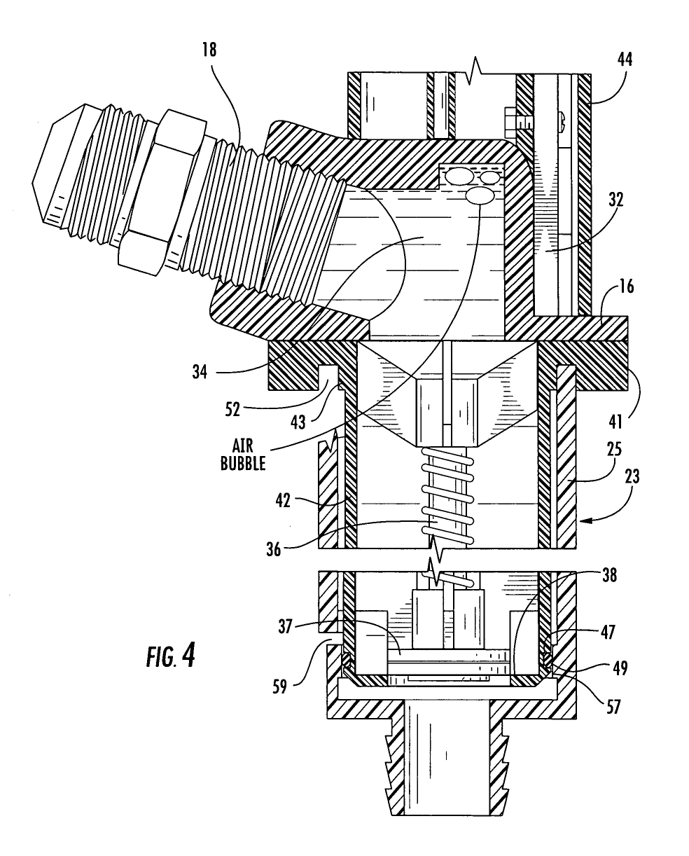

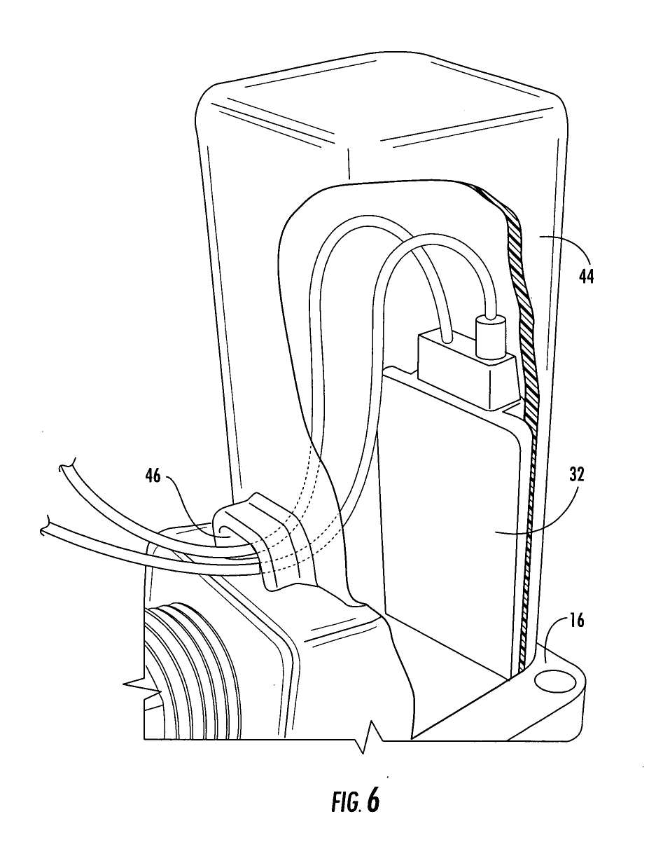

As best seen in FIG. 4, liquid travels up through the axially extending flow passageway defined by the quick disconnect assembly 22 and into the body 16. The body 16 contains a head space 34 into which the liquid flows before it exits through the pump-side connector 18. In the embodiment shown, the top wall of the body 16 defines a recess or chamber located above the level of the pump-side connector 18 and opposite the connector 18 to entrap air bubbles that may come into the coupling device 2. A hollow protective enclosure or housing 44 is mounted to the upper side of body 16. The enclosure 44 houses a sensor 32 and shields it from contact. As best seen in FIG. 4, sensor 32 is mounted to the body 16 adjacent to the bubble entrapment area, from which location it is able to monitor the flow of liquid through the head space 34 and sense when air bubbles enter the coupling. When the container 4 is pumped almost empty and air begins to be drawn from the container 4 through the flow passageway of the coupling device 2, the sensor 32 detects the presence of air bubbles in the liquid. One suitable type of sensor for this purpose is a capacitive sensor, such as for example model number KNQ01NUKFPKG/AS manufactured by Ifm Electronic (Essen, Germany). Capacitive sensors detect changes in dielectric properties within the sensor's field. Air bubbles entering the head space 34 of the coupling device will alter the dielectric field and the capacitive sensor can thus detect this change and generate a signal used to automatically stop the pumping of the container 4 before more air is drawn into the system. As seen in FIG. 6, the wiring that connects the sensor 32 to the pumping system control circuitry exits the hollow enclosure 44 through a small hole 46.

When container 4 is empty and the pump is shut down, the quick disconnect assembly 22 makes it possible to quickly disconnect the coupling device 2 from the dip tube 10 of the empty container and to reconnect it to the dip tube for a full container. The releasable friction fit interconnection is broken by grasping the outside surface 28 of the female coupling member and twisting while exerting a force axially downwardly away from the male coupling member 24.

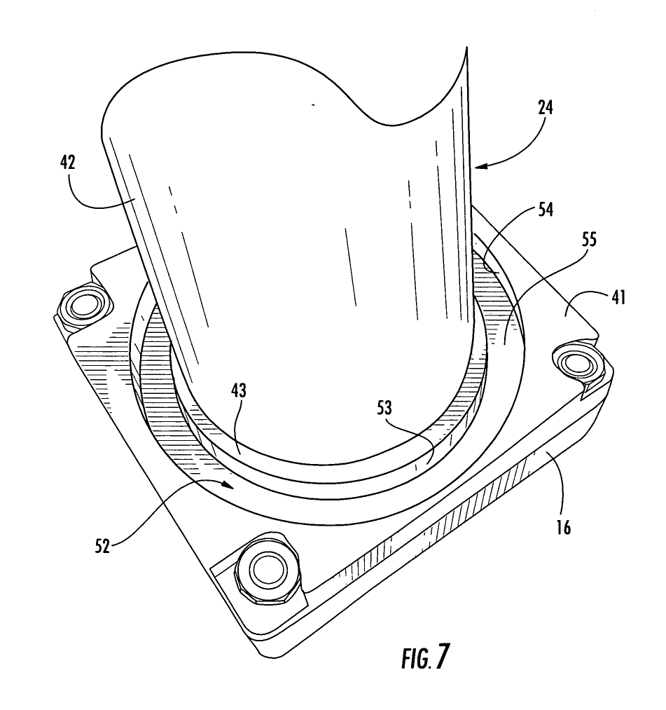

As best seen in FIGS. 4 and 7, the male coupling member 24 includes a base 41 attached to body 16 and a cylindrical tubular wall 42 that extends from the base. The base 41 has a smooth upper surface that mates with a corresponding smooth lower surface of the body 16 to provide a modular construction for the coupling device 2. The body 16 and base 41 are held together in assembled, sealed relationship by threaded fasteners. This allows for the parts to be readily manufactured by injection molding and also allows for servicing the coupling device 2, e.g. repairing or replacing the check valve, without the necessity of disconnecting hoses. The tubular wall 42 has substantially uniform diameter over substantially its entire axial extent. However, where the wall 42 adjoins the base 41, there is an enlarged diameter shoulder 43 and an adjoining an annular channel 52 defined by an outwardly facing axially extending cylindrical surface 53, an opposed inwardly facing axially extending cylindrical surface 54 and interconnected by a channel bottom wall 55. The thickness the cylindrical wall 25 of the female coupling member 23 at its forwardmost end corresponds to the spacing between the surfaces 53, 54 of the annular channel. To join the male and female coupling members 24, 23, the user moves the female coupling member 23 axially over the male coupling member until the forwardmost end of the cylindrical wall 25 the contacts the channel 52. The female coupling member is then twisted or rotated to cause the forwardmost end of the cylindrical wall 25 to enter the channel 52 where it forms a releasable friction fit or interference fit between the walls 53, 54 of the channel 52.

In the embodiment shown, a circumferentially extending groove 47 is formed in the outwardly facing cylindrical exterior surface of the male coupling member 24 adjacent the distal end of the coupling member and an O-ring seal 49 is positioned in the groove to assure a fluid-tight leakproof seal between the coupling members. The inwardly facing cylindrical interior surface of the female coupling member 23 has a reduced diameter shoulder portion 57 adjacent the bottom which is positioned to bear against the O-ring 49 to form a seal. The strength of the friction fit interconnection is enhanced by the friction between the O-ring 49 in the groove 47 and the interior shoulder portion 57 of the female coupling member.

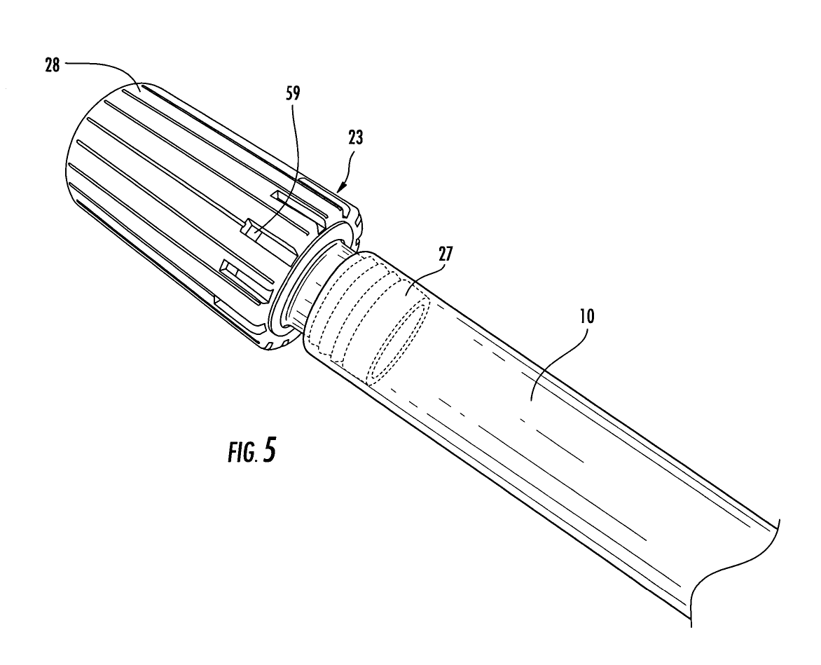

As best seen in FIG. 5, a series of radially spaced apart axially extending slots are formed in the wall 25 of the female coupling member 23 adjacent the end that is connected to the dip tube 10. The slots extend partially through the wall thickness over a portion of the length, and entirely through the wall 25 at one end to define vent openings 59. The vent openings 59 allow for the venting of air from the dip tube 10 and coupling assembly 2 when the coupling members 23, 24 are assembled and when the dip tube is inserted into a filled container. As seen in FIG. 4, the vent openings 59 also allow for any chemical that may be trapped above the O-ring 49 to drain from the coupling assembly.

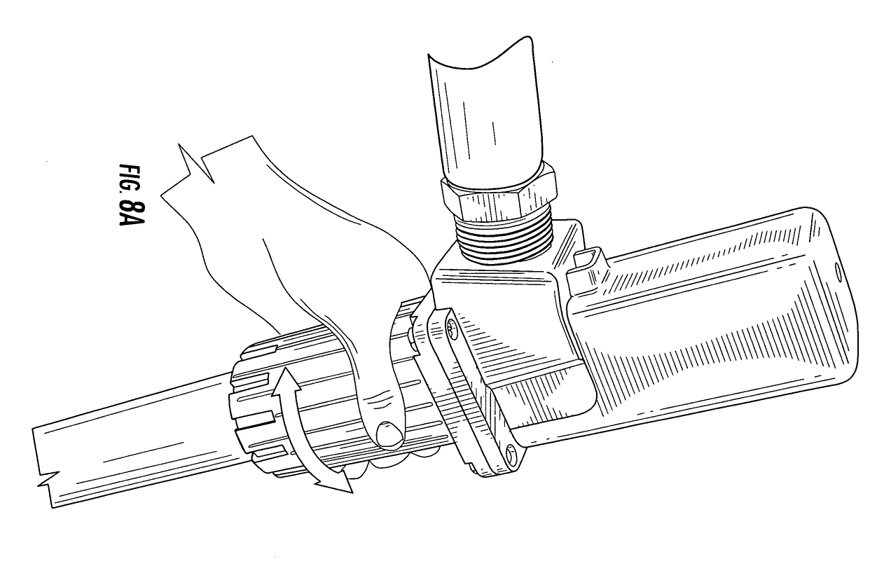

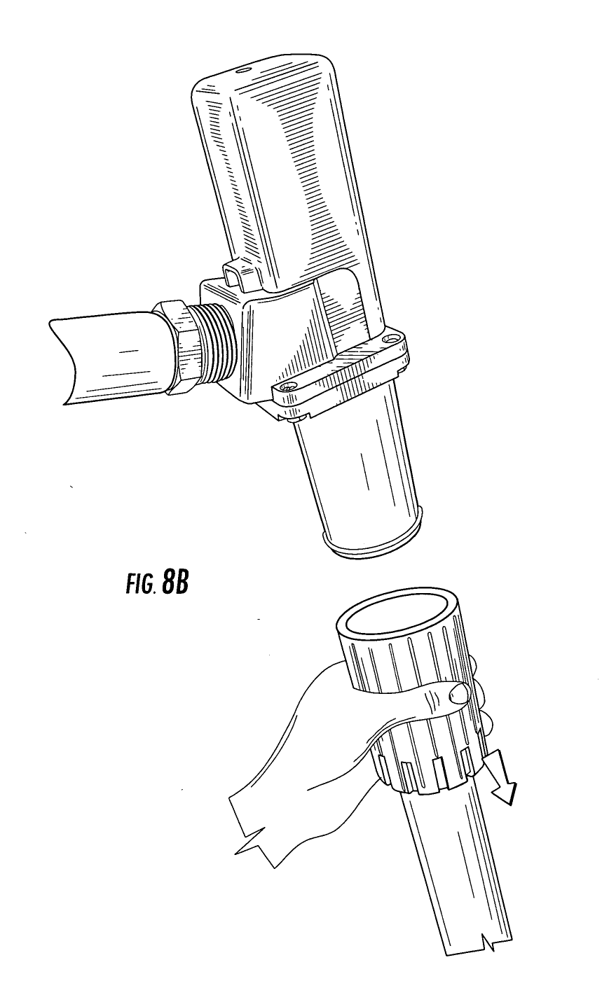

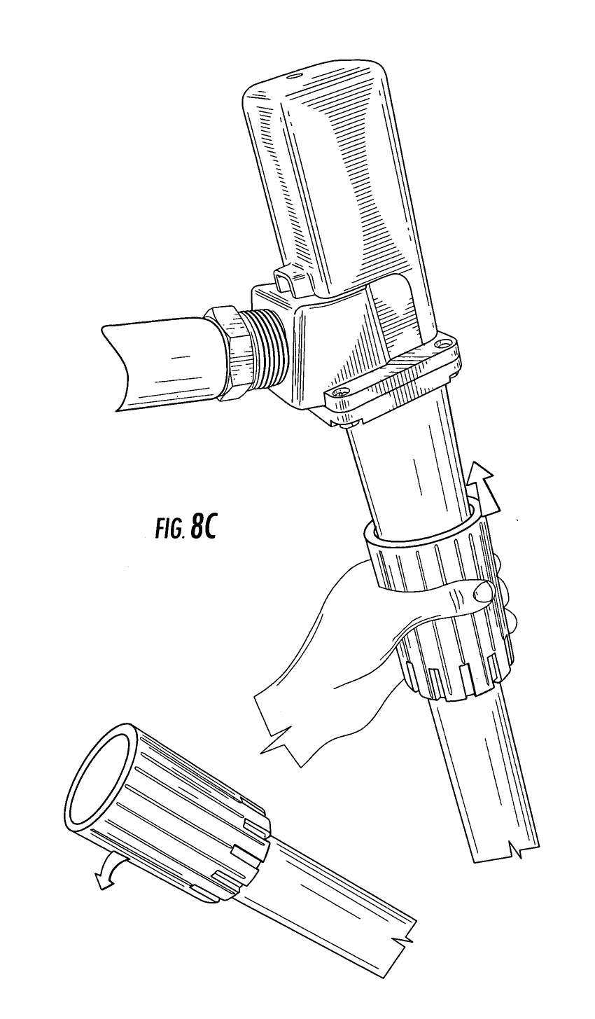

FIGS. 8A-8C demonstrate the ease with which the coupling device 2 can be switched between containers. In FIG. 8A, the upper part of the female member 23 is secured in the channel 52. The user of the coupling device 2 twists the female member 23, as shown in FIG. 8A, and simultaneously exerts a downward force on it by pulling down. This combined motion causes the female member 23 to dislodge from the channel 52. After the female member 23 dislodges from the channel 52, the user can slide the female member 23 axially to remove it from the male coupling member 24. As previously mentioned, in one embodiment of the invention, the dip tube 10 remains engaged with or attached to the female member 23, and the two components can be discarded as a pair, as shown in FIG. 8C. The user can then reconnect the male coupling member 24 to the female coupling member 23 of a new dip tube 10 in a full container.

Referring once more to FIGS. 8A-8C, using the coupling device 2 is easy and convenient. The pumping system P attached to the coupling device 2 at the pump-side connector 18 can stay connected to the male coupling member 24 while several different containers are emptied. The coupling device 2 thus is ideal for use with several containers having the same chemicals since such use does not require the coupling device 2 to be cleaned when switching containers. In any case, the coupling device 2 minimizes the amount of parts needed to be discarded, thereby making the process of emptying containers more efficient and less costly. The quick switching of only a few components of the coupling device 2 also makes the process less messy.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for dispensing liquid from a container having an opening through which the liquid may be withdrawn from the container, said system comprising:
a dip tube having a first end adapted to be inserted into the container through the opening and having an opposite second end; and
a coupling device for connecting a pump to said dip tube, the coupling device including a body, a pump-side connector adapted to be connected to a pump, and a container-side connector; the container-side connector comprising a quick disconnect assembly defining an axially extending flow passageway therethrough and including a tubular male coupling member having an outwardly facing cylindrical exterior surface, and a cooperating tubular female coupling member configured to receive said male coupling member and having an inwardly facing cylindrical surface arranged to engage a portion of the outwardly facing cylindrical surface of the male coupling member to releasably interconnect the male and female coupling members in assembled relationship, and wherein said female coupling member is provided at said opposite end of said dip tube.

2. The system of claim 1, wherein said coupling device further includes a sensor operable to monitor the flow of liquid through the coupling device.

3. The system of claim 2, wherein the sensor is a capacitive sensor operable to detect when air begins to be pumped through the coupling device, thus indicating that the container is empty.

4. The system of claim 3 further including a head space within said coupling device into which liquid pumped from the dip tube passes, and wherein the sensor is located adjacent the head space.

5. The system of claim 1, wherein said coupling device further includes a check valve operable to prevent liquid from flowing back from the coupling device through the container-side connector.

6. The system of claim 1, including a circumferentially extending groove formed in the cylindrical surface of at least one of said coupling members, and a seal positioned in said groove.

7. The system of claim 1, wherein said male coupling member of said quick disconnect assembly extends from said coupling body, and said female coupling member receives said male coupling member for releasably connecting the coupling device to said dip tube.

8. The system of claim 7, wherein said female coupling member has an outwardly facing cylindrical surface configured to be seated in the opening of the container so that the dip tube is supported within the container, and including a series of grooves formed in said outwardly facing cylindrical surface and providing an air passageway into the container when the female coupling member is seated in the opening of the container.

9. The system of claim 8, including a series of vent openings formed in said female coupling member at spaced locations about said cylindrical surface thereof.

10. A system for dispensing liquid from a container having an opening through which the liquid may be withdrawn from the container, said system comprising:
a dip tube having a first end adapted to be inserted into the container through the opening and having an opposite second end; and
a coupling device for connecting a pump to said dip tube, said coupling device comprising a body, a pump-side connector adapted to be connected to a pump, and a container-side connector; the container-side connector comprising a quick disconnect assembly defining an axially extending flow passageway therethrough and including a tubular male coupling member extending from said body and having an outwardly facing cylindrical exterior surface, a cooperating tubular female coupling member having an open first end configured to receive said male coupling member, a connector at the opposite end thereof for connection to said dip tube, an inwardly facing interior cylindrical surface arranged to engage a portion of the outwardly facing cylindrical surface of the male coupling member to releasably interconnect the male and female coupling members in assembled relationship, and an outwardly facing cylindrical external surface configured to be seated in the opening of the container so that the dip tube is supported within the container.

11. The system of claim 10, wherein said coupling device further includes a sensor operable to detect when air begins to be pumped through the coupling device, thus indicating that the container is empty, and a check valve operable to prevent liquid from flowing back from the coupling device through the container-side connector.

12. The system of claim 10, wherein said connector for connection to said dip tube comprises a barbed friction-fit connector.

13. A coupling device for connecting a pump to a dip tube inserted into a container of liquid to be pumped, said coupling device comprising a body, a pump-side connector adapted to be connected to a pump, and a container-side connector adapted to be connected to a dip tube; the container-side connector comprising a quick disconnect assembly defining an axially extending flow passageway therethrough and including a tubular male coupling member having an outwardly facing cylindrical exterior surface, and a cooperating tubular female coupling member configured to receive said male coupling member and having an inwardly facing interior cylindrical surface arranged to engage a portion of the outwardly facing cylindrical surface of the male coupling member to form a releasable interconnection that will hold the male and female coupling members in assembled relationship.

14. The coupling device of claim 13, further including a sensor operable to monitor the flow of liquid through the coupling device.

15. The coupling device of claim 14, wherein the sensor is a capacitive sensor operable to detect when air begins to be pumped through the coupling device, thus indicating that the container is empty.

16. The coupling device of claim 15 further including a head space within said coupling device into which liquid pumped from the dip tube passes, and wherein the sensor is located in the head space.

17. The coupling device of claim 13, further including a check valve operable to prevent liquid from flowing back from the coupling device through the container-side connector.

18. The coupling device of claim 13, including a circumferentially extending groove formed in the surface of at least one of said connectors, and a seal positioned in said groove.

19. The coupling device of claim 12, wherein said male coupling member of said quick disconnect assembly extends from said coupling device body, and said female coupling member is connected to a dip tube and receives said male coupling member for releasably connecting the coupling device to the dip tube.

20. The coupling device of claim 19, wherein said female coupling member has an axially outwardly facing cylindrical outer surface to facilitate manually twisting the female coupling member when connecting and disconnecting the coupling members.

21. A coupling device for connecting a pump to an end of a dip tube projecting from a container of liquid to be pumped, said coupling device comprising a body, a pump-side connector adapted to be connected to a pump, and a container-side connector adapted to be connected to a dip tube; the container-side connector comprising a quick disconnect assembly defining an axially extending flow passageway therethrough and including a tubular male coupling member extending from said body and having an outwardly facing cylindrical exterior surface, a cooperating tubular female coupling member having an open first end configured to receive said male coupling member, a connector at the opposite end thereof adapted to connect to a dip tube, an inwardly facing interior cylindrical surface arranged to engage a portion of the exterior cylindrical surface of the male coupling member to form a releasable friction fit that will releasably hold the male and female coupling members in assembled relationship, and an outwardly facing cylindrical external surface configured to be seated in the opening of the container so that the dip tube is supported within the container.

22. The coupling device of claim 21, wherein said coupling device further includes a sensor operable to detect when air begins to be pumped through the coupling device, thus indicating that the container is empty, and a check valve operable to prevent liquid from flowing back from the coupling device through the container-side connector.

23. The coupling device of claim 21, wherein said connector for connection to said dip tube comprises a barbed friction-fit connector.

24. The coupling device of claim 21, including a circumferentially extending groove formed said axially outwardly facing exterior cylindrical surface of the male coupling member and an O-ring seal positioned in said groove.

25. The coupling device of claim 24, including a series of vent openings formed in said female coupling member at spaced locations about said cylindrical surface thereof, said vent openings being located adjacent to said groove and O-ring seal.
